(19) United States
(12) Patent Application Publication
(10) Pub. No.: US 2001/0037673 A1
(43) Pub. Date: Nov. 8, 2001

(54) SOLDER PASTE TESTER

(76) Inventor: LIAM T. JACKSON, GLOUCESTER (GB)

Correspondence Address: JOHN E BECK, XEROX CORPORATION, XEROX SQUARE 20A, ROCHESTER, NY, 14644

(21) Appl. No.: 09/265,053

(22) Filed: Mar. 9, 1999

(51) Int. Cl. G01N 11/10

(52) U.S. Cl. 73/54.23; 73/54.36

(57) ABSTRACT

An apparatus for measuring the viscosity of a fluid is provided. The apparatus includes a vessel for containing a supply of the fluid and a member. The member is positionable within the vessel for displacement within the fluid. The apparatus also includes a measuring mechanism connected to the member and operably associated with the vessel for measuring the force required to displace the member within the fluid. The measuring mechanism is adapted to measure the force required to displace the member within the fluid. The force is indicative of the viscosity of the fluid.

This invention relates generally to testing solder, and more particularly concerns a method and apparatus for testing viscosity of solder paste.

Modern machinery and equipment often include controls which include printed circuit boards. The printed circuit boards may be simple, including resistors and other simple components or may be more complicated and include surface mounted devices and thus be in the form of a printed wiring board assemblies. The components within a printed circuit board are mounted on a non-conductive substrate or board typically in the form of plastic such as a phenolic for example Bakelite® a trademark of BP Chemicals, Ltd. The components mounted on the board are interconnected electrically by means of a conductive material.

For durability, simplicity and to provide for an inexpensive printed circuit board, preferably, the components are interconnected by the use of a soldered path placed upon the printed circuit board. The soldered path may be placed upon the printed circuit board by any suitable method. One such method for applying the solder to the printed circuit board is by applying the solder through a mask including a series of apertures which permit the solder to pass therethrough thus forming the pattern of solder upon the printed circuit board. After the soldered pattern is placed upon the circuit board, the circuit board is heated and the surface mounted devices as well as the electrical components are applied to the heated solder to secure the components thereto. This process of printed circuit board assembly is known as a surface mount. A solder paste is utilized to form the solder which is placed upon the printed circuit board.

Solderability, the ability of the solder to be formed onto the printed circuit board and for the solder to be heated and properly secure the electrical components thereto, is a huge concern in the production environment. Any batch to batch variations in board to electrical component Solderability can have disastrous effects on production yields. Difficulties with Solderability may be due to the electrical components which are later secured to the printed circuit board. The components may be stored for a significant period of time prior to assembly and thereby deteriorate. The coating thickness on the component may be inadequate. Also, the quality of the component plating may be poor.

Solderability problems can be categorized into four major categories. The first of these categories is wettability. Wettability is a function of the surface properties and depends on environmental degradation, for example, oxidation and the alloy composition of the surface. Wettability is the biggest variable of the four factors.

The second of the categories is thermal demand. Thermal demand relates to the thermal mass of the lead frame connected to the soldered pad. For good solderability to occur, the temperature must be hot enough but due to limited times in the equipment in which the solder is heated in the printed wiring board, there is only a limited time for soldering. A small thermal mass is thus desirable for securing the components to the solder during the re-flowing process.

The third of these categories is the resistance to soldering heat. The resistance to soldering heat is wholly dependent on the materials used to make the device. Some components may work fine for production but may have serious impact on rework.

The fourth of the categories is joint design. Joint design is fixed within the component style. However, for example, modifications can be made to the joint design to improve the solderability.

Solderability problems can lead to a defective circuit board in that the circuit board includes a portion of the soldering path that is not a sufficiently good electrical conductor. These types of problems are typically called dry joint problems. The dry joint problems may be due to an insufficient solder paste in an aperture due to a partially blocked aperture, no solder paste in an aperture due to a completely blocked aperture, electrical components or devices with bent or misshapen legs, poor solderability of the printed circuit board itself, incorrect temperature of the printed circuit board during the reflowing process, poor solderability of the electrical component itself, or old or dry solder paste. Problems with old or dry solder paste are particularly a problem in a manufacturing environment.

Solder paste has a workable life of approximately eight hours. The only element that noticeably changes with the condition of the paste is the thickness. The older the paste, the thicker the consistency. This change in thickness is due to the evaporation of flux. The flux is added to the paste to enable cleaning of the soldered joints. If the flux has mostly evaporated, then poor soldering will occur. The thickening of the paste also causes the apertures in the screen to block more frequently. If the blockages are not removed immediately, little or no solder paste will be deposited onto the printed circuit board. This is a cause of dry joints. Therefore, as the paste ages, the operator is forced to clean the screen more frequently. The cleaning of the screen more frequently has two undesirable effects. The first effect is that the process is slowed as there is more machine down time. Secondly, the cleaning fluid that is used to clean the screens degrades the solder paste. Any overspray onto the paste while cleaning the screen will reduce the life of the remaining paste.

It is therefore desirable to inspect the condition of the solder paste prior to its use in manufacturing printed circuit boards. Attempts have been made to measure the thickness of solder paste prior to its use. For example, a drip test has been used to determine the thickness of the paste. The drip test works by measuring the time taken known for a quantity of material to pass through an aperture or an opening. The drip test is inadequate in that due to the extreme thickness of the paste, the time taken for the paste to pass through the aperture is excessive, making the drip test an impractical solution to a production test method.

Another method known as the rotary strain gauge method is shown in FIG. 10. Referring to FIG. 10, a prior art paste thickness measuring apparatus 1 is shown. In the apparatus 1, a sample of solder paste 2 is placed in a vessel 3. A blade 4 attached by shaft 5 to a motor 6 is submersed into the solder paste 2. A strain gauge 7 is utilized to measure the resistance caused by the solder 2 to the rotation of the blade 4 within the solder 2. The apparatus 1 as shown in FIG. 10 is not effective in accurately measuring the thickness of the paste 2. This is because the paste 2 has a property that causes it to be viscotropic. The more that you mix the paste 2, the warmer and the thinner the paste 2 will become. The warming and mixing effect on the paste 2 as the blade 4 rotates within the paste 2, causes the paste 2 to thin and warm giving a false reading from the strain gauge 7.

Other methods of measuring the viscosity of solder paste include a drip test. A drip test works by measuring the time taken for a known quantity of material to pass through an aperture or opening.

Both the use of the rotary strain gauge and the drip test is inadequate for testing the thickness of solder paste. The use of the rotary strain gauge causes both a warming and a mixing effect on the paste. Such a warming and mixing causes the paste to thin giving a false reading. The utilization of a drip test also is inadequate due to the extreme thickness of the paste. The time taken for the paste to pass through the aperture is excessive for a production type inspection.

The present invention is directed to solve, at least some of the aforementioned problems with solder paste measurement.

The following disclosures may be relevant to various aspects of the present invention:

### U.S. Pat. No. 5,827,951

### Patentee: Yost et al.

### Issue Date: Oct. 27, 1998

### U.S. Pat. No. 5,751,900

### Patentee: Bryant et al.

### Issue Date: May 12, 1998

### U.S. Pat. No. 5,656,933

### Patentee: Frederickson et al.

### Issue Date: Aug. 12, 1997

### U.S. Pat. No. 5,485,392

### Patentee: Frederickson et al.

### Issue Date: Jan. 16, 1996

### U.S. Pat. No. 5,234,151

### Patentee: Spigarelli

### Issue Date: Aug. 10, 1993

### U.S. Pat. No. 5,022,556

### Patentee: Dency et al.

### Issue Date: Jun. 11, 1991

The relevant portions of the foregoing disclosures may be briefly summarized as follows:

U.S. Pat. No. 5,827,951 discloses a new test method to quantify capillary flow solderability on a printed wiring board surface finish. The test is based on solder flow from a pad onto narrow strips or lines. A test procedure and video image analysis technique were developed for conducting the test and evaluating the data. Feasibility tests revealed that the wetted distance was sensitive to the ratio of pad radius to line width (l/r), solder volume, and flux pre-dry time.

U.S. Pat. No. 5,751,910 discloses a solder paste brick inspection and physical quality scoring system 10 employs a neural network 70 trained with a fuzzified output vector. An image of solder paste bricks 64 on a printed circuit board 12 is acquired by a CCD camera 30. Values of a predetermined set of brick metrics are extracted from the image by a computer 28 and used as a crisp input vector to trained neural network 70. A defuzzifier 76 converts a fuzzy output vector from neural network 70 into a crisp quality score output which can be used for monitoring and process control.

U.S. Pat. No. 5,656,933 discloses an on-line statistical process control device for solder paste and residues. The invention consists of electronics hardware, software, and probing systems. The electrical hardware of the invention provides voltage and current measurements of solder paste materials, the software of the invention controls the hardware, provides real-time complex, nonlinear least squares curve fitting for equivalent circuit analysis, data storage and retrieval of circuit parameters and behavior, and statistical process control tracking and charting. The probing systems of the invention allows for 2, 3, and 4 probe surface and bulk measurements of the solder paste and residues.

U.S. Pat. No. 5,485,151 discloses a system for monitoring the soldering process which comprises a soldering means including a means for monitoring analog heat flow, a means, connected to the soldering means, for converting analog heat flow readings into a digital temperature data points, a computing means, connected to the means for converting analog heat flow readings into digital data points, which smoothes the temperature data points; locates the beginning of the temperature data point decay; locates the beginning of the temperature data point recovery; calibrates the system for monitoring the soldering process; and classifies the current temperature data point input as an iron cleaning operation or a soldering operation.

U.S. Pat. No. 5,234,151 discloses a method is provided for non-contact and contact sensing of phase changes of a solder material. By adding solder to a preexisting solder joint or substrate, an infrared sensor with limited resolution capability is able to discriminate between various solder characteristics at the solder enhanced site and other thermally distracting components when the solder transitions from a solid to a liquid phase or from a liquid to a solid phase. One type of contact sensing of solder reflow is accomplished by holding a thermocouple against a solder joint. When the pre-existing solder volume is insufficient to produce the desired results, additional solder is added to the solder joint or lead. The additional solder may be solid solder, a solder pre-form, or solder paste. Contact sensing may also be achieved by placing a spring loaded probe against the solder and detecting the probe's movement as the solder softens. In another contact reflow detection technique, a thermocouple sensor is housed in a protective sleeve fillable with solder paste or molten solder. The sensor is placed against a substrate adjacent a solder joint, and is heated simultaneously with the solder joint. Detection of solder reflow in the sleeve by the thermocouple signals reflow of the adjacent solder joint.

U.S. Pat. No. 5,022,556 discloses a programmable volume dispensing apparatus having a positive displacement metering pump for dispensing varying amounts of high viscosity fluids such as soldering paste. The metering pump comprises a positive displacement metering pump and a digitally driven drive motor under programmable control. The drive motor is connected to the volume adjustment of the pump via a chain and sprocket mechanism. The chain and sprocket mechanism adjusts a stop which controls the stroke of the pump and the volume of fluid dispensed. In an alternate embodiment a flexible rotary drive shaft controls the stroke of the pump and the volume of fluid dispensed. Different volumes of solder can be dispensed to different areas and shapes of pads on a circuit board in accordance with preprogrammed dispensing commands.

All of the above references are hereby incorporated by reference.

### SUMMARY OF THE INVENTION

In accordance with one aspect of the present invention, there is provided an apparatus for measuring the viscosity of a fluid. The apparatus includes a vessel for containing a supply of the fluid and a member. The member is positionable within the vessel for displacement within the fluid. The apparatus also includes a measuring mechanism connected to the member and operably associated with the vessel for measuring the force required to displace the member within the fluid. The measuring mechanism is adapted to measure the force required to displace the member within the fluid. The force is indicative of the viscosity of the fluid.

Pursuant to another aspect of the present invention, there is provided a method for measuring the viscosity of a fluid. The method includes the steps of placing a supply of the fluid in a vessel, inserting a member into the vessel and in contact with the fluid, moving the member within the fluid, measuring the force required to move the member within the fluid, and determining the viscosity of the fluid based on the force required to move the member within the fluid.

Pursuant to yet another aspect of the present invention, there is provided an apparatus for measuring the viscosity of a solder. The apparatus includes a vessel for containing a supply of the solder. The vessel defines an opening thereof. The apparatus also includes a member positionable within the vessel for displacement within the solder. The member is insertable into the vessel through the opening into a cavity within the vessel. The member includes a surface thereof substantially perpendicular to the direction of the displacement of the member. The apparatus further includes a displacement mechanism connected to the member and operably associated with the vessel for linearly and vertically displacing the member within the solder. The apparatus also includes a measurement mechanism adapted to measure the force required to displace the member within the solder. The force is indicative of the viscosity of the solder. The apparatus further includes a hydraulic cylinder operably associated with measurement mechanism for measuring the force required to displace the member. The measurement mechanism is adapted to measure the force required to displace the member by measuring the pressure within the hydraulic cylinder required for the displacement mechanism to displace the member. The apparatus further includes a display operably associated with the measurement mechanism for displaying an indication of the viscosity of the solder. The display may include a plurality of lights. Each of the lights indicates a certain viscosity range. The display may include a numerical representation of the viscosity of the solder. The apparatus further includes a controller operably associated with at least one of the measurement mechanism and the displacement mechanism for at least one of controlling at the movement of the member and of determining the viscosity of the solder based on the force required to displace the member within the solder.

### IN THE DRAWINGS

Other features of the present invention will become apparent as the following description proceeds and upon reference to the drawings, in which:

FIG. 1 is a plan view partially in section of a first embodiment of the solder testing apparatus of the present invention utilizing cylinder type member;

FIG. 2 is a plan view partially in section of a second embodiment of the solder testing apparatus of the present invention utilizing blade type member;

FIG. 3 is a plan view partially in section of the solder testing apparatus of FIG. 1 utilizing a display and a controller;

FIG. 4 is an plan view of the solder testing apparatus of FIG. 1;

FIG. 5 is a side view of the solder testing apparatus of FIG. 4;

FIG. 6 is a partial plan view of the solder testing apparatus of FIG. 4;

FIG. 7 is a top view of a printed circuit board made from a screen soldering process including solder which may be tested using the solder testing apparatus of the present invention;

FIG. 8 is a top view of a screen soldering apparatus which utilizes solder which may be tested using the solder testing apparatus of the present invention and which may be used to manufacture the printed circuit board of FIG. 7;

FIG. 9 is a cross sectional view along the line 9-9 in the direction of the arrows of the FIG. 8 screen soldering apparatus; and

FIG. 10 is a plan view partially in section of prior art solder testing apparatus.

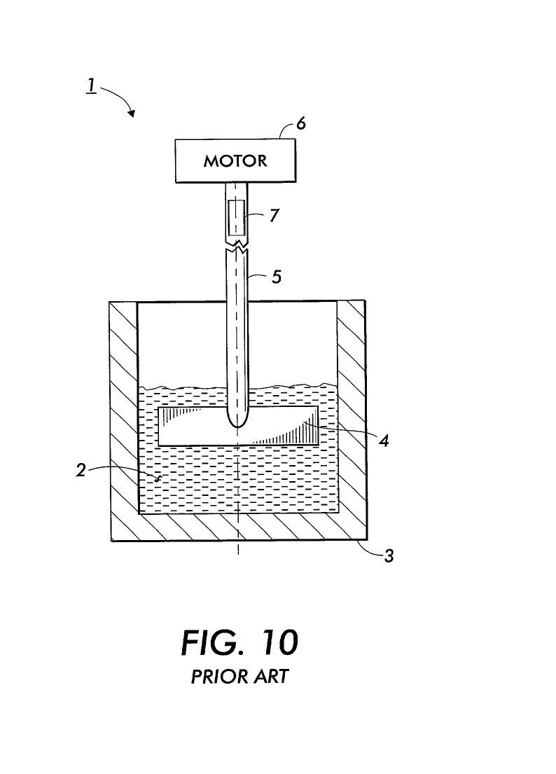

### DETAILED DESCRIPTION

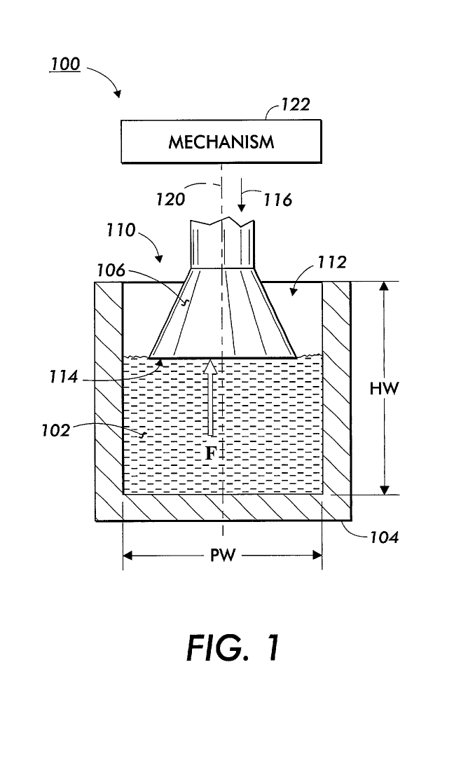

According to the present invention and referring now to FIG. 1, an apparatus 100 for measuring the viscosity of a fluid 102 is shown. The apparatus 100 includes a vessel 104 for containing a supply of the fluid 102. While the apparatus 100 may be utilized to determine the viscosity of any fluid, it should be appreciated that the apparatus 100 is particularly well adapted for those fluids which have a property of being viscotropic. A viscotropic fluid is a fluid that as you mix the fluid, the fluid becomes warmer and as it becomes warmer, the fluid becomes thinner or less viscous.

The apparatus 100 further includes a member 106 which is positionable within the vessel 104 for displacement of the fluid 102 within the vessel 104.

Preferably, and as shown in FIG. 1, the vessel 104 defines an opening 110 permitting access without the vessel 104 to a cavity 112 formed by the vessel 104.

The vessel 104 may be made of any suitable, durable material, for example, a metal or plastic and is preferably non chemically reactive with the member 106. The vessel 104 may have any suitable shape and size capable of containing a quantity of fluid 102. For simplicity, the vessel 104 may be in the form of a cylinder. The vessel 104 is preferably large enough to provide for an accurate measurement of the fluid 102 yet small enough to minimize the amount of fluid 102 utilized to conduct the measurement of the fluid 102. For example, and as shown in FIG. 1, the vessel 104 may have an inner diameter PW and a height HW. For example, the inner diameter PW may be from 0.1 inches to 10 inches, and the height HW may be from 1 inch to 10 inches.

The member 106 may have any suitable shape and may be made of any suitable, durable material capable of displacing the fluid 102. For example, the member 106 may be made of a metal or a plastic that is not chemically reactive with the fluid 102. For example, for durability and to withstand elevated temperatures, the member 106 may be made of a metal, i.e. stainless steel.

The member 106 may have any suitable shape capable of displacing the fluid 102. For simplicity and to obtain accurate measurements of the fluid properties of the fluid 102, preferably, the member 106 includes a surface 114 thereof which is substantially perpendicular to the direction 116 of the displacement of the member 106.

While it should be appreciated that the member 106 may displace the fluid 102 in any path in which the fluid 102 may be displaced, for simplicity and to assure accurate measurements of the property of the fluid 102, the direction 116 of the displacement of the member 106 within the fluid 102 is preferably substantially linear.

To provide for a simple apparatus 100 which may allow for easy filling and removal of the fluid 102 from the vessel 104, the direction of displacement of the member 106 is substantially vertical with centerline axis 120 of the member 102 being collinear with the direction 116 of the displacement of the member 106. By providing for the vertical displacement of the member 106, the member 106 may be insertable into the vessel 104 through the opening 110 into the cavity 112 of the vessel 104.

As shown in FIG. 1, the apparatus 100 further includes a measuring mechanism 122 which is connected to the member 106. The measuring mechanism 122 is utilized for measuring the force required to displace the member 106 within the fluid 102. The measuring mechanism 122 is thus operably associated with the vessel 104. The measuring mechanism 122 may thus be fixedly positioned with respect to the vessel 104 such that movement of the member 106 with respect to the measuring mechanism 122 results in the measuring mechanism 122 measuring the force required for the member 106 to be moved with respect to the vessel 104 thereby causing the member 106 to be displaced within the fluid 102.

The measuring mechanism 122 is adapted to measure a force F required to displace the member 106 within the fluid 102. The force F is indicative of a physical property of the fluid. The physical property of the fluid 102 may be the viscosity of the fluid.

The member 106 may be moved by any translating mechanism capable of movement of the member 106. The translating mechanism (not shown) may be in the form of a mechanically actuated system requiring physical input from an operator such as the movement of a lever or crank arm or be automated or motorized with any suitable device. For example, the translating mechanism may include a motor for generating the force required to move the member 106. The translating mechanism may be electromechanical, hydraulic, or pneumatic. The selection of the proper of the electromechanical, hydraulic or pneumatic operation of the translating mechanism is best governed by a translating mechanism which may provide a steady displacement of the member 106 to assist the measuring mechanism of providing an accurate measurement of the force F required to displace the member 106.

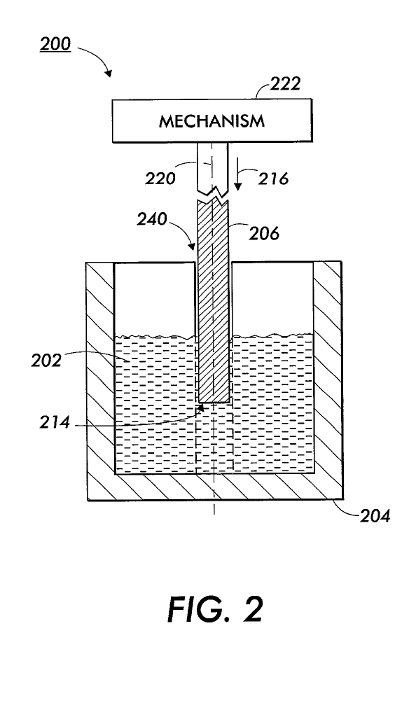

While the present invention may be practiced with an apparatus having a generally cylindrical member such as member 106 of apparatus 100, it should be appreciated that other member shapes may be utilized for the apparatus of the present invention. For example, and now referring to FIG. 2, apparatus 200 is shown utilizing a member 206 in the form of a plate or blade. The apparatus 200 is similar to the apparatus 100 of FIG. 1 except that apparatus 200 of FIG. 2 includes a blade shaped member 206 which has a displacement in the direction of arrow 216 along centerline axis 220 of the member 206.

The force exerted upon the member 206 is measured by mechanism 222 which is similar to measuring mechanism 122 of FIG. 1. The vessel 204 is similar to the vessel 104 of FIG. 1 except that the vessel 204 may be elongated to correspond to the shape of member 206. The vessel 204 may include a vertical aperture 240 which provides for the motion of the member 206 in the direction of arrow 216. The apertures 240 may result in a portion of the fluid 202 escaping from the vessel 204.

Referring again to FIG. 2, the member 206 may be cantilevered outside the vessel 204. A strain gauge (not shown) may be directly connected to the member 206. The deflection of the blade may be detection by the strain gauge giving a change in voltage that could be measured.

Slot 240 in the apparatus 200 in addition to allowing the paste to escape, the thinner the paste, the higher the risk of the escape of the paste from the apparatus 200. The escaping of the paste from the apparatus 200 in addition to causing housekeeping problems will reduce the pressure on the blade 206 thereby reducing the accuracy of the test.

The apparatus 100 of FIG. 1 may be preferred over the apparatus 200 of FIG. 2 in that the force required to displace the member 106 may be greater than the force required to displace the member 206 because frontal surface 214 of the member 206 is much smaller than the surface 114 of the member 106 thereby requiring much less force for the displacement of member 206. The much lesser force required for displacement of member 206 may make measurements of the force for the apparatus 200 more difficult to accurately measure.

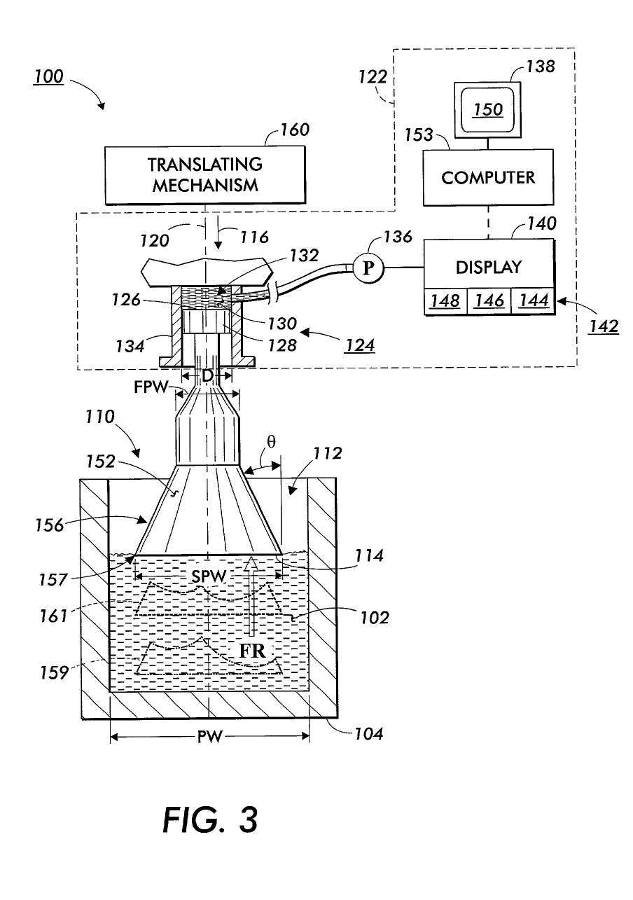

Referring now to FIG. 3, the apparatus 100 is shown with measuring mechanism 122 in greater detail. While it should be appreciated that any measuring mechanism capable of determining the force required to displace the member 106 through the fluid 102 may fall within the scope and spirit of the invention it should be appreciated that for example the measuring mechanism 122 may include a hydraulic cylinder 124. The hydraulic cylinder 124 is associated with the member 106 and is utilized to measure the resistance force FR applied by the fluid 102 onto surface 114 of the member 106.

Referring again to FIG. 3, in order to obtain an accurate measurement of the viscosity of the fluid 102 within the vessel 104, preferably, the force FR which equates to a pressure P is more accurately determined and more accurately representative of the viscosity of the fluid 102 when the force FR is determined in the midpoint of the travel from first position 157 to second position 159 as shown in phantom in FIG. 3. The utilization of a normally open dual pole changeover switch may be utilized to hold the voltage felt at the pressure switch when midpoint through the solder paste. Such as utilization gives an accurate measurement of the pressure in the middle of the movement of the member 106.

Referring again to FIG. 3, as the member 106 travels downwardly in the direction of arrow 116, the surface 114 contacts the fluid 102. At the point that the member 106 contacts the fluid 102, the resistance starts to be detected by the pressure sensor 136. When the surface 114 of the member 106 reaches midpoint 161 through the vessel 104, a measuring switch is made and a measuring voltage is held. The operator of the apparatus 100 thus utilizes this method to note the maximum resistance upon the fluid 102.

As shown in FIG. 3, the hydraulic cylinder 124 is movable upward and downward along the axis 120 and moves downward in the direction of arrow 116 causing the member 106 to move downward through the fluid 102.

Hence, the resistance force FR pushes upwardly against surface 114 of the member 106. Correspondingly, an outer surface 126 of the piston portion 128 of the member 106 applies a pressure to hydraulic fluid 130 within cavity 132 cylindrical housing 134 of the hydraulic cylinder 124. The pressure exerted within the cavity 132 of the hydraulic cylinder 124 is measured by, for example, pressure sensor 136.

The pressure sensor 136 may be any suitable commercially available pressure sensor. Accurate pressure sensors are widely used to day in applications such as medical infusion pumps, robotic end-effectors, and kidney dialysis machines.

The pressure sensor 136 is preferably accurate and provides a linear output. Preferably, a minimal error occurs over the full range of the measuring range of the pressure sensor 136 and requires minimal electronics to operate. Preferably, the overall dimensions of the pressure sensor 136 should be appropriate to enable the tester to be portable and usable in an industrial environment. The pressure sensor 136 may be any commercially available pressure sensor and may be a Honeywell FS Sensor. The Honeywell FS Sensor may read a pressure within the range of 1 gram Force to 1 kg Force with an accuracy of ±1 gram Force.

As shown in FIG. 3, the apparatus 100 may further include a display 140 which is operatively associated with the measuring mechanism 122. The display 140 is utilized for displaying an indication of the viscosity of the fluid. As shown in FIG. 3, the display 140 may be utilized to measure the pressure P within the cavity 132 of the hydraulic cylinder 124.

The display 140 may be in any form. For example, the display 140 may include a plurality of lights 142. Each of the lights 142 may be an indication of a certain viscosity range. For example, the plurality of lights 142 may include a first light 144 corresponding to a range from 0 to 10 psi, representing a viscosity of too thin, a second light 146 corresponding to an acceptable viscosity range including a pressure of 10 psi to 50 psi, and a third light 148 corresponding to a pressure range corresponding to a pressure range above 50 psi representing the viscosity being too thick.

The display 140 may, in addition to, or alternatively to, the plurality of lights 142 include a numerical representation 150. The numerical representation may be an actual display of the pressure recorded by the pressure sensor 136. The numerical representation 150 may be in a gauge form or in an electronic display such as display 138, either in the form of a CRT or in the form of a series of LED or liquid crystal displays.

To obtain a numerical representation 150 in the display 138, a ADC module such as a Pico unit is utilized. The Pico unit is connected to a parallel port of a portable computer 153. The portable computer 153 will convert the analog signal from the conditioning circuit within the pressure sensor 136 to a digital value. The portable computer 153 can then store the information and display it a number of ways, i.e. a decimal value or a graphical format. The utilization of the portable computer 153 will assist in analyzing new solder paste compositions and selecting the range for an acceptable application of the solder paste. The use of the portable computer 153 will provide for much more accurate reading.

For simplicity and to provide for accurate measurements of the viscosity of the fluid 102, preferably the member 106 includes the surface 114 which preferably is perpendicular to longitudinal axis 142 representing the direction of motion of the member 106. Further, to assist in ensuring the accurate measurement of the viscosity of the fluid 102, preferably the member 106 is configured such that the drag caused by sides 152 of the member 106 are minimized.

One way to minimize the drag upon the sides 152 is to provide for a first portion 154 of the member 160 which may be connected or operatively associated with the measuring mechanism 122. The first portion 154 defines a first portion width FPW perpendicular to the longitudinal axis 120. The first portion width FPW is less than the width SPW of the surface 114.

Further, as shown in FIG. 3, the member 106 may include a second portion 156 which extends from the first portion 154. The second portion 156 includes the surface 114 and therefor defines the second portion width SPW. The first portion width FPW is less than the second portion width SPW so that drag of the fluid 102 against the first portion 154 will be minimized as the member moves within the fluid 102.

Alternatively, or in conjunction with the first portion 154 and the second portion 156, preferably, and as shown in FIG. 3, the sides 152 extending from the surface 114 of the member 106 are angled inwardly to reduce the drag upon the member 106 as it passes through the fluid 102. The side walls 152 may be defined by an angle θ from the vertical axis 120 of, for example, 5° to 45°. As shown in FIG. 3 angle θ may be, for example, 25°.

While it should be appreciated that the measuring mechanism 122 and the member 106 may be moved through the fluid 102 by any suitable method and may be moved manually or by use of a power apparatus, for example and as shown in FIG. 3, the apparatus 100 further includes a translation mechanism 160 for translating the measuring mechanism 122 and the member 106 upwardly and downwardly along the axis 120.

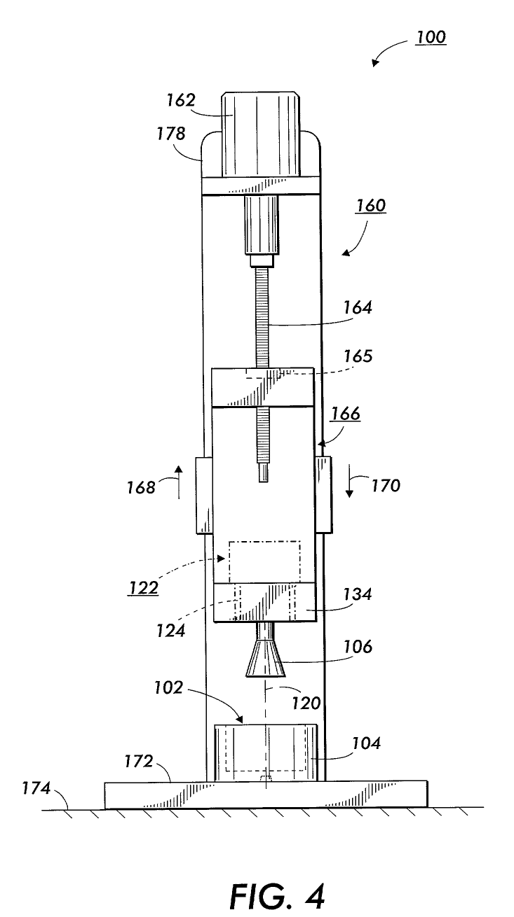

The translating mechanism 160 may be any mechanism capable of translating the member 106 upwardly and downwardly along axis 120. For example, the translating mechanism 160 may be hydraulically driven, mechanically driven, or electrically driven. For example, as shown in FIG. 4, the translating mechanism 160 may be mechanically driven by an electric motor 162.

The motor 162 maybe any suitable motor, and may for example, be a hydraulic motor, a pneumatic motor, or an electrical motor. The electrical motor 162 should be chosen to provide for an accurate translational speed of the member 106 through the fluid 102. The motor 162 is thus preferably a positioning motor, for example an internally geared 12 volt DC motor.

Referring again to FIG. 4, the utilization of the integrally gear 12 volt d.c. motor 162 is particularly effective for the operation as the motor 162 is not effected by loss of torque when the supply voltage is reduced.

The motor 162 preferably includes an actuator 164 for translating the power of the motor 162 to cause the member 106 to move upwardly and downwardly in the direction of axis 120. The actuator 162, as shown in FIG. 4, is in the form of a screw. The screw 164 is threadably engaged to nut 165 located in a slide 166 for controllably moving the slide 166 upwardly and downwardly along axis 120. The slide 166 is utilized to mount the member 106 thereto.

Referring again to FIG. 4, the utilization of the screw 164 with an integrally geared motor 162 permits the reversing of polarity of the supply voltage of the motor to easily control the direction of the motor to move the slide 166 upwardly and downwardly along axis 120. The speed of the motor 162 may be directly linked to the voltage supplied to the motor 162. By varying the voltage of the motor 162, the speed can be controlled with no loss of torque to the screw 164 of power to the slide 166. A voltage supply of 10 volts d.c. may be adequate.

For example, as shown in FIG. 4, the member 106 is mounted to the measuring mechanism 122 which includes the hydraulic cylinder 124. Housing 134 of the cylinder 124 is fixedly secured to the slide 166 and moves therewith. As the motor 162 rotates, the screw 164 likewise rotates with the motor 162 and causes the slide 166 to move upwardly and downwardly in the direction of arrows 168 and 170, respectively.

To interconnect the motor 162 to the member 106 and provide support for the components of the apparatus 100, as shown in FIG. 4, the apparatus 100 includes a base 172 for mounting the apparatus 100 to the floor 174. It should be appreciated that the apparatus 100 may similarly be mounted to a bench or other component. As shown in FIG. 4, the apparatus 100 may likewise include a support 176 extending upwardly from the base 172. As shown in FIG. 4, the vessel 104 may be positioned on the base 172 and the motor 162 may be mounted to the support 176.

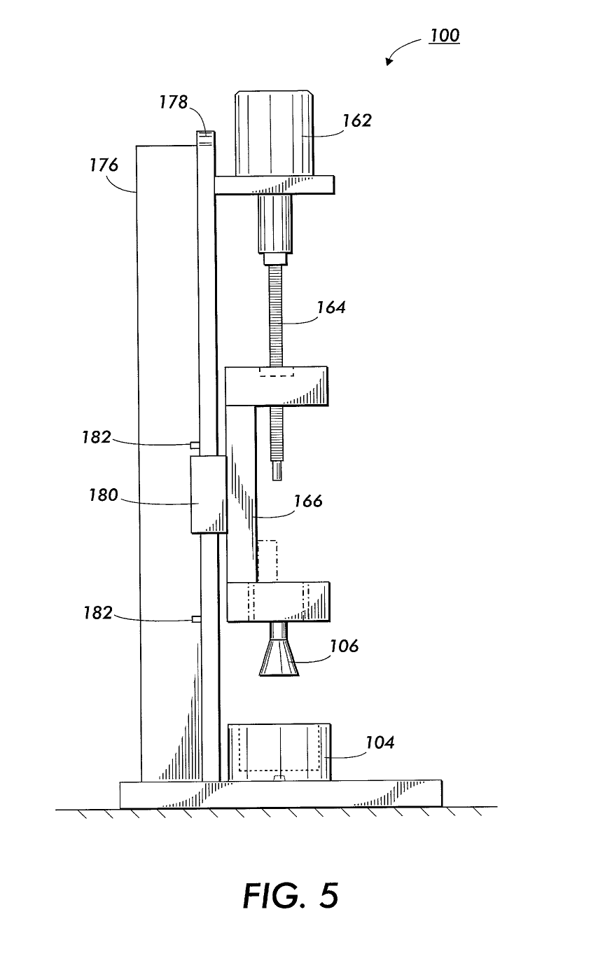

Referring now to FIG. 5, the support 176 is shown in greater detail. To provide for the raising and lowering of the member 106 along axis 120, for example, and as shown in FIG. 5, the slide 166 is slidably mounted to the support 176. While the slide 166 may be mounted to the support 176 in any suitable fashion, for example the support 176 includes a pair of support ways 178 which are mounted to the supports 176. Similarly, the slide 166 includes a pair of slide ways 180 which are slidably engageable with the support ways 178. The lead screw 164 thus engages with the slide 166 to advance the slide 166 upwardly and downwardly along the ways 178 and 180. To limit the travel of the slide 166, preferably the slide 166 includes limit switches 182 which limit the travel of the slide 166.

The ways 178 and 180 may be, for example, in the form of a linear bearing. Such a linear bearing allows accurate and smooth operation. The shaft or screw 164 may be made of any suitable material, for example, a mild steel, and the nut 165 within the slide 166 may be made of a compatible material, i.e. phosphor bronze.

The support 176 and the slide 166 may be made of any suitable durable material and may, for example, be made of a plastic or a metal. For example, and to provide for a durable apparatus 100 and to simplify construction, the support 176 and the base 172 may be made of, for example, aluminum. The support 176 and the base 172 may, for example, be welded to each other.

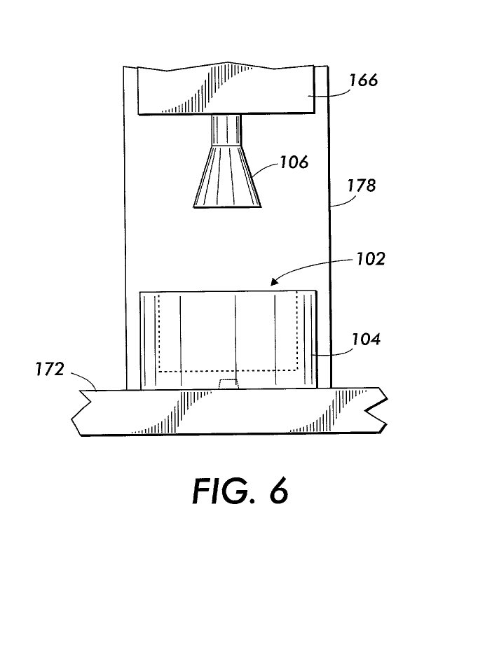

Referring now to FIG. 6, the apparatus 100 is shown with the slide 166 positioned over the vessel 104. The member 106 is shown positioned above the vessel 104. In the position as shown in FIG. 6, fluid 102 may be added to the vessel 104. It should be appreciated that the vessel 104 may be removed from the base 172 such that the vessel may be emptied and refilled with an additional sample of fluid 102.

To assist in alignment of the vessel 104 with the apparatus 100 when repositioning the vessel into the apparatus, the vessel 104 may contain a location feature in, for example, the form of a recess which mates with a location feature in, for example, the form of a protrusion on the base 172 of the apparatus 100. It should be appreciated that the location feature on the base 172 and vessel 104 may be in the form of location rings or location rails (not shown). The location feature assists in positioning the member 106 centrally with respect to the vessel 104 so that the force required to move the member 106 within the vessel may be consistent between solder tests.

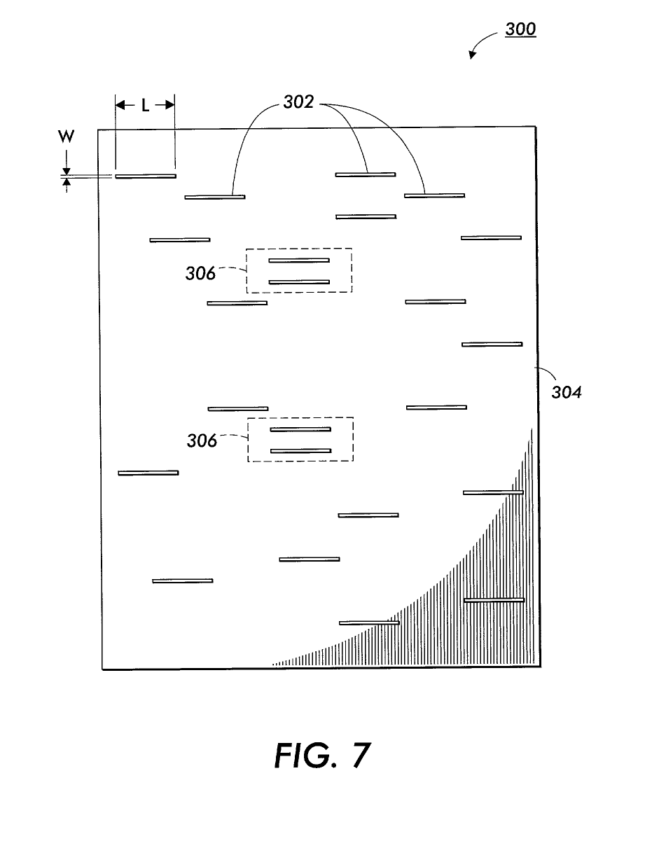

Referring now to FIG. 7, an integrated circuit 300 is shown. The integrated circuit 300 includes solder joints 302 which may be applied with a solder which may be tested for proper viscosity with the apparatus 100 of the present invention. The solder joints 302 are applied to an integrated circuit board 304 which may be made of any suitable durable material. For example, the circuit board 304 may be made of a plastic, for example, a phenolic such as Bakelite®, a trademark of BP Chemicals, Ltd. The solder joints 302 are utilized to interconnect electrical components 306. The electrical components 306 may be any component, including a simple resistor or capacitor or may be a complex transistor or an integrated circuit.

The solder joints 302 may be made of any particular solder and is typically in the form of a solder composed mostly of a lead and tin mixture and may be mixed with flux for form a paste. For example, the solder may be 60% lead and 40% tin. It should be appreciated that any commercially used solder may be tested with the apparatus 100 of the present invention.

The solder joint 302 of the integrated circuit 300 of FIG. 7 may be applied to the circuit board 304 in any suitable manner. For example, the solder joints 302 may be manually applied or applied with any of a variety of automated techniques. The measurement of the solder utilized for the solder joint may be measured utilizing the apparatus 100 of the present invention regardless of the applying technique used for applying the solder joints 302.

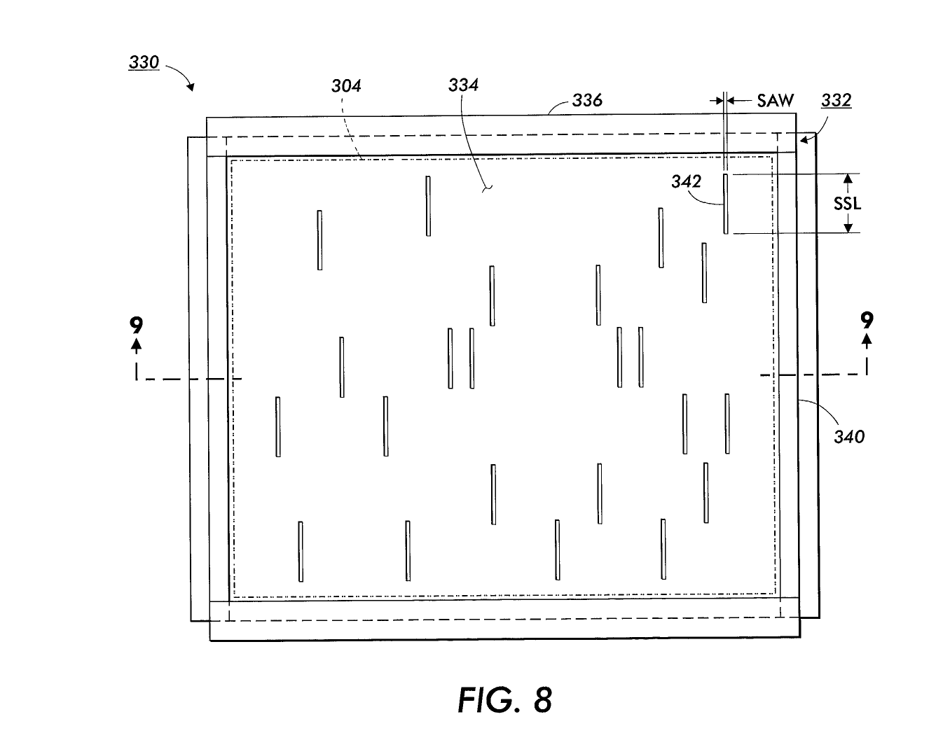

One such method for applying the solder joints 302 to the integrated circuit 300 of FIG. 7 is the use of a silkscreen process. Such a silkscreen process is shown in FIGS. 8 and 8.

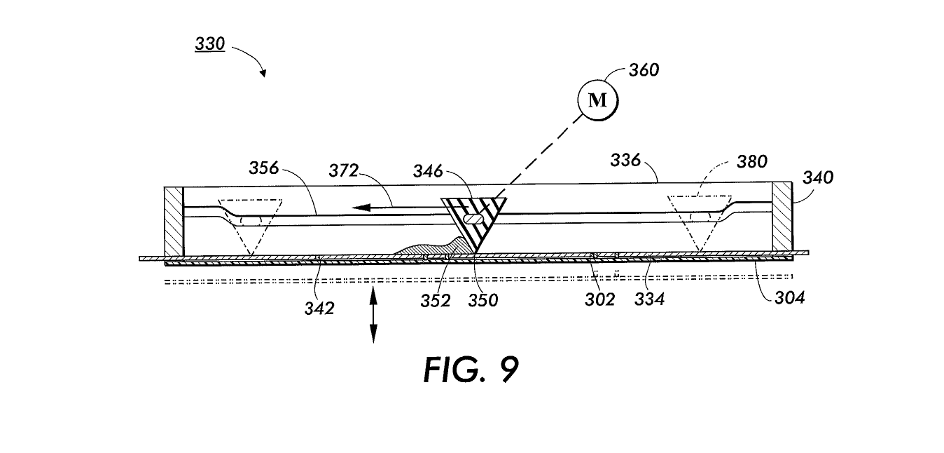

As shown in FIGS. 8 and 9, a silk-screening apparatus 330 is shown for use in the manufacture of the integrated circuit 300 of FIG. 7. A silk-screening apparatus 330 includes a frame 332, about which a screen 334 is taughtly secured. The frame 332 typically includes two longitudinal frame members 336 and two transverse frame members 340. The frame is made from a rigid, durable material such as reinforced plastic or metal. The screen 334 is made of a flexible material that does not stretch or creep (i.e. stainless steel) in order that the pattern thereon may be accurately reproduced onto the integrated circuit board 304. Apertures 342 are cut or formed into the screen 334. The apertures 342 form a pattern which corresponds to the pattern upon the integrated circuit board 304.

The apertures 342 preferably consist of spaced apart slits having a length SSL generally equal to the length L of the solder joints 302 and having a screen aperture width SAW generally equal to the width W of the solder joints 302 (See FIG. 7). The slits 342 are separated from each other. The width W of the solder joints 302 is typically 0.05 mm to 3.0 mm and the length L of the solder joints may vary widely depending of the positions of the components on the integrated circuit 300.

Referring now to FIG. 9, a carriage 344 is located above the screen 334 and extends in a transverse direction and is supported by longitudinal members 336 of the frame 332. The carriage 334 includes a squeegee device 346 preferably in the form of a resilient blade. The resilient blade 346 may have any suitable shape, but typically has a triangular cross section with a lower edge 350 contactable with the screen 334. Solder paste 352 is placed in the silk-screening apparatus 330 between the edge 350 of the resilient blade 346 and the screen 334. The solder paste 352 may be any suitable solder paste which may, for example, include lead and tin mixed with a flux.

The solder paste 352 preferably has a viscosity sufficiently low to permit the solder paste 352 to pass through the apertures 342 of the screen 334 as the screen moves relative to the squeegee device 346. The consistency of a paste has been found to be particularly effective in permitting a uniform flow of the solder paste 352 through the aperture 342 while permitting the solder paste 352 to remain on the integrated circuit 300 during the silk-screening process and during drying and firing.

The integrated circuit 300 in a partially manufactured condition is placed beneath the screen 334 and is aligned with the screen 334 such that the electrical components 306 may be properly interconnected by the resulting solder joints 302 from the silk-screening process.

The silk-screening apparatus 330 is so configured to provide for screen slits 342 so that the solder paste 352 oozing through the slits 342 with the screen aperture with SAW of the screen 334 being equal in width to the width W of the solder joints 302 on the integrated circuit 300 and such that the screen spacing with SAW on the screen 334 is equal to the length L of the solder joint 302 on the integrated circuit 300. It should be appreciated that the width W and the aperture width SAW as well as the silkscreen length and the length L may differ slightly from each other as to account for the dynamics of the silk-screening process.

As shown in FIG. 9, the circuit board 304 is positioned under the silk-screening apparatus 330. The integrated circuit board 304 may be secured to the silk-screening apparatus 330 by any suitable method. For example, by clamps or by a vacuum chuck or any similar fixing apparatus (not shown).

The squeegee device 346 in the form of a resilient blade moves longitudinally in the direction of arrow 372 along, for example, a channel 356.

The upper surface of the circuit board 304 is spaced below the screen 334. The screen 334 may be in contact with the circuit board 304 or may be spaced from the circuit board 304 in order to prevent the smearing of the solder joints 302 and to prevent the drying of the solder joint 302 within slits 342.

To apply the solder joint 302 to the circuit board 304, the solder paste 352 is placed between the resilient blade 346 and the screen 334 when the resilient blade 346 is in a first position 380. As the resilient blade 346 moves in the direction of arrow 372, the solder paste 352 is forced through the slit 342 onto the circuit board 304. The resilient blade 346 is moved in the direction of arrow 372 by any suitable power source, or by hand along the channel 356. For example, a motor 360 may be used to translate the resilient blade 346. When the resilient blade 346 has reached a second position 382, the resilient blade 346 has urged the solder paste 352 through all the slits 342 forming all the solder joints 302 into the circuit board 304. The circuit board 304 is then lowered away from the silk screening apparatus 334 by a mechanical apparatus (not shown) to a position shown in phantom. The circuit board 304 is then carried away from the apparatus by, for example, a conveyor (not shown) for further processing and a subsequent circuit board 304 is placed into the silk screening apparatus 334 for processing.

By providing an apparatus for measuring the viscosity of a viscotropic material including a member which is displaced through the fluid and the force required to displace the member is measured, an accurate measurement of the viscosity of the fluid can be determined.

By providing a numerical representation of the force required to displace a member through a viscotropic material an accurate measurement of the viscosity of the fluid may be determined.

By providing an apparatus for measuring the viscosity of a viscotropic material including a plurality of lights with each of the lights indicating a certain viscosity, an acceptable/non-acceptable measuring device can be simply provided.

By providing an apparatus for measuring a viscotropic material including a hydraulic cylinder for absorbing a pressure from the displacement of a member through the fluid an accurate measurement of the resistance of the member and a corresponding accurate measurement of the viscosity of the fluid can be determined.

By providing an apparatus for measuring a viscotropic material which translates literally through the material with a leading surface perpendicular to the material a simple and accurate measurement of the of the viscosity of the fluid can be determined.

It is, therefore, apparent that there has been provided in accordance with the present invention, an injection gate control for molding plastic parts that fully satisfies the aims and advantages hereinbefore set forth. While this invention has been described in conjunction with specific embodiments, it is evident that many alternatives, modifications, and variations will be apparent to those skilled in the art. Accordingly, it is intended to embrace all such alternatives, modifications and variations that fall within the spirit and broad scope of the appended claims.

1. An apparatus for measuring the viscosity of a fluid, comprising:
a vessel for containing a supply of the fluid;
a member positionable within said vessel for displacement within the fluid;
a measuring mechanism connected to said member and operably associated with said vessel for measuring the force required to displace said member within the fluid, said measuring mechanism adapted to measure the force required to displace said member within the fluid, the force being indicative of the viscosity of the fluid.

2. An apparatus, as claimed in claim 1:
wherein the direction of the displacement of said member within the fluid is substantially linear; and
wherein said member includes a surface thereof substantially perpendicular to the direction of the displacement of said member.

3. An apparatus, as claimed in claim 1:
wherein said vessel defines an opening thereof; and
wherein said member is insertable into said vessel through said opening into a cavity within said vessel.

4. An apparatus, as claimed in claim 1, further comprising a displacement mechanism for displacing said member within the fluid.

5. An apparatus, as claimed in claim 1:
further comprising a hydraulic cylinder operably associated with said measuring mechanism for measuring a force required to displace the member; and
wherein said measuring mechanism is adapted to measure the force required to displace said member by measuring the pressure within said hydraulic cylinder required to displace said member.

6. An apparatus, as claimed in claim 1, further comprising a display operably associated with said measuring mechanism for displaying an indication of the viscosity of the fluid.

7. An apparatus, as claimed in claim 6, wherein said display includes a plurality of lights, each of said lights indication a certain viscosity range.

8. An apparatus, as claimed in claim 6, wherein said display includes a numerical representation of the viscosity of the fluid.

9. An apparatus, as claimed in claim 1, wherein said member comprises:
a first portion thereof connected to said measuring mechanism, said first portion defining a first portion width perpendicular to the direction of the displacement of said member; and
a second portion thereof extending from said first portion, said second portion defining a second portion width perpendicular to the direction of the displacement of said member, the first portion width being less than the second portion width so that drag of the fluid with said first portion will be reduced as the member moves within the fluid.

10. An apparatus, as claimed in claim 1, further comprising a controller operably associated with said measuring mechanism for at least one of controlling of the movement of the member and of determining the viscosity of the fluid based on the force required to displace said member within the fluid.

11. A method for measuring the viscosity of a fluid, comprising the steps of:
placing a supply of the fluid in a vessel;
inserting a member into the vessel and in contact with the fluid;
moving the member within the fluid;
measuring the force required to move the member within the fluid;
determining the viscosity of the fluid based on the force required to move the member within the fluid.

12. The method according to claim 11:
wherein the step on moving the member comprises linearly moving the member; and
wherein the inserting step comprises inserting a member having a surface thereof substantially perpendicular to the direction of the displacement of said member.

13. The method according to claim 11:
wherein the step of placing a supply of the fluid comprises placing a supply of the fluid in a vessel defining an opening thereof; and
wherein the step of inserting a member into the vessel comprises inserting the member into the vessel through the opening into a cavity within the vessel.

14. The method according to claim 11, wherein the step of moving the member within the fluid comprises vertically moving the member within the fluid.

15. The method according to claim 11:
wherein the step of moving the member within the fluid comprises the step of providing a hydraulic cylinder for providing a force to move the member within the fluid; and
wherein the step of measuring the force required to displace the member comprises the step of measuring the pressure within the hydraulic cylinder required to displace said member.

16. The method according to claim 11, further comprising the step of displaying an indication of the viscosity of the fluid.

17. The method according to claim 16, wherein the step of displaying includes the step of providing a plurality of lights, each of the lights indicating a certain viscosity range.

18. The method according to claim 16, wherein the step of displaying includes the step of providing a numerical representation of the viscosity of the fluid.

19. The method according to claim 11, wherein the step of inserting a member into the vessel, comprises inserting a member into the vessel having a shape so that drag of the member within the fluid will be reduced as the member moves within the fluid.

20. The method according to claim 11, further comprising at least one of the step of controlling of the movement of the member and the step of determining the viscosity of the fluid based on the force required to displace the member within the fluid.

21. An apparatus for measuring the viscosity of a solder, comprising:
a vessel for containing a supply of the solder, said vessel defining an opening thereof;
a member positionable within said vessel for displacement within the solder, said member being insertable into said vessel through said opening into a cavity within said vessel, said member including a surface thereof substantially perpendicular to the direction of the displacement of said member;
a displacement mechanism connected to said member and operably associated with said vessel for linearly and vertically displacing said member within the solder
a measurement mechanism adapted to measure the force required to displace said member within the solder, the force being indicative of the viscosity of the solder;
a hydraulic cylinder operably associated with measurement mechanism measuring the force required to displace the member, said measurement mechanism adapted to measure the force required to displace said member by measuring the pressure within said hydraulic cylinder required for said displacement mechanism to displace said member;
a display operably associated with said measurement mechanism for displaying an indication of the viscosity of the solder, said display including at least one of a plurality of lights, each of said lights indication a certain viscosity range and a numerical representation of the viscosity of the solder; and
a controller operably associated with at least one of said measurement mechanism and said displacement mechanism for at least one of controlling at the movement of the member and of determining the viscosity of the solder based on the force required to displace said member within the solder.
